(19) United States
(12) Patent Application Publication
(10) Pub. No.: US 2026/0119953 A1
(43) Pub. Date: Apr. 30, 2026

(54) 3D POINT CLOUD PROCESSING USING QUANTUM GRAPH NEURAL NETWORKS

(71) Applicants: IonQ, Inc., College Park, MD (US); Hyundai Motor Company, Seocho-gu, Seoul (KR); Kia Corporation, Seoul (KR)

(72) Inventors: Daiwei ZHU, College Park, MD (US); Jason IACONIS, Boulder, CO (US); Evgeny EPIFANOVSKY, Arlington, VA (US); Doyeon KIM, Seongnam-si, Gyeonggi-do (KR); Donghyeon KIM, Gangseo-gu, Seoul (KR); Hanlae JO, Gangnam-gu, Seoul (KR); Rakhoon HWANG, Seongnam-si, Gyeonggi-do (KR); Sungmok HWANG, Seocho-gu, Seoul (KR)

(21) Appl. No.: 19/061,890

(22) Filed: Feb. 24, 2025

Related U.S. Application Data
(60) Provisional application No. 63/693,526, filed on Sep. 11, 2024.

(51) Int. Cl. G06N 10/60; G06N 3/04

(52) U.S. Cl. CPC G06N 10/60; G06N 3/04

(57) ABSTRACT

Aspects of the present disclosure relate generally to systems and methods for using a quantum graph neural network (QGNN) for processing three-dimensional (3D) point cloud data. The method includes sampling clusters of points derived from an original point cloud. The method also includes generating an input graph of the QGNN by aggregating each of the points from a particular cluster independently into a corresponding feature vector such that each vertex of the input graph corresponds to an individual cluster of nodes. The method also includes generating node-wise feature vectors comprising a global feature vector or a node-wise feature vector by processing the input graph using the QGNN. The method finally includes performing at least one of a segmentation, classification or detection task using the node-wise feature vectors.

### CROSS REFERENCE TO RELATED APPLICATIONS

This application claims priority to U.S. Patent Provisional Application No. 63/693,526, filed Sep. 11, 2024, the entire contents of which are hereby incorporated by reference.

### TECHNICAL FIELD

Aspects of the present disclosure relate generally to systems and methods for use in the implementation, operation, and/or use of a quantum graph neural network framework for three-dimensional point cloud processing.

### BACKGROUND

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, control, and/or functionality of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of techniques for implementing a quantum graph neural network (QGNN) framework that is configured to incorporate graph symmetry of underlying problems to efficiently solve graph-based data-driven tasks.

In some aspects of the present disclosure, a method of using a QGNN for processing three-dimensional (3D) point cloud data. The method includes sampling clusters of points derived from an original point cloud. The method also includes generating an input graph of the QGNN by aggregating each of the points from a particular cluster independently into a corresponding feature vector such that each vertex of the input graph corresponds to an individual cluster of nodes. Each node including an original center coordinate of a local cluster and a feature vector. The feature vectors corresponding to vertex feature vectors of the input graph. The method also includes generating node-wise feature vectors comprising a global feature vector or a node-wise feature vector by processing the input graph using the QGNN. The node-wise feature vectors of each vertices represents a property of a local cluster. The method also includes performing at least one of a segmentation, classification or detection task using the node-wise feature vectors.

In some aspects of this present disclosure, a system configured to process three-dimensional (3D) point cloud data using a QGNN is described. The system includes at least a pre-processor configured to sample clusters of points derived from an original point cloud, and generate an input graph of the QGNN by aggregating each of the points from a particular cluster independently into a corresponding feature vector such that each vertex of the input graph corresponds to an individual cluster of nodes. Each node including an original center coordinate of a local cluster and a feature vector. Feature vectors correspond to vertex feature vectors of the input graph. The system also includes a QGNN configured to: generate node-wise feature vectors comprises a global feature vector or a node-wise feature vector by processing the input graph with the QGNN. The node-wise feature vectors of each vertices representing a property of a local cluster. The system also includes a post-processor configured to perform at least one of a segmentation, classification or detection task using the node-wise feature vectors.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions in a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates an example of a design of a quantum graph neural network framework in accordance with aspects of this disclosure.

FIG. 5 illustrates an example of a message-passing section of the QGNN in accordance with aspects of this disclosure.

FIG. 6 illustrates an example of a readout section of the QGNN in accordance with aspects of this disclosure.

FIG. 7 illustrates an example of processing graph data with a quantum graph neural network model in accordance with aspects of this disclosure.

FIG. 8 illustrates a pipeline for 3D point cloud processing with QGNN in accordance with aspects of this disclosure.

FIGS. 9A-H illustrates detailed steps of a 3D point cloud processing with QGNN in accordance with aspects of this disclosure.

FIG. 10 illustrates an example of processing 3D point cloud data using a QGNN in accordance with aspects of this disclosure.

Like reference numbers and designations in the various drawings indicate like elements.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well-known components.

Graph neural networks (GNNs) have emerged as a pivotal advancement in the field of machine learning. GNNs offer an innovative framework for processing and analyzing graph-structured data. Unlike traditional neural network architectures that excel in handling Euclidean data such as images and text, GNNs are specifically designed to tackle non-Euclidean data represented in graphs. This capability enables the application of deep learning techniques to a broader spectrum of problems, including but not limited to social network analysis, biomolecular structure prediction, and complex network systems analysis.

These types of graph-structured problems are pervasive spanning from traffic predictions to molecular medicine. In addition, GNNs have seen success in treating these graph-structured problems due to its intrinsic compatibility with structure of graphs. However, traditional classical GNNs encounter challenges in adequately capturing the overarching structural dependencies with these types of graphs, which shines light on many potential practical benefits of quantum machine learning.

At the core of GNN's design is the automorphism symmetry of a graph. Graph automorphism symmetry refers to the invariance of a graph under certain permutations of its vertices. In other words, an automorphism of a graph is a permutation of the vertices that preserves the structure of the graph. GNN transforms data through a series of interconnected layers, similar to standard neural networks, but with a specific mechanism to preserve the underlying automorphism symmetry of the underlying graph. For example, a form of GNN, a message-passing (MP) GNN preserves the automorphism symmetry of the graph problem by representing the feature vector at each layer into node feature vectors on each vertex, and restricting the connections between node feature vectors of adjacent layers to only those connected by edges. Due to the built-in compatibility with the symmetry of the graph problem, MP GNN adeptly captures the complex dependencies and interactions among nodes, thereby facilitating a nuanced understanding of the data's inherent structure.

The advent of GNNs has significantly expanded the applicability of neural models to domains characterized by intricate relational data while simultaneously presenting novel challenges. For example, traditional classical GNNs encounter challenges in adequately capturing the overarching structural dependencies within these graphs, which illuminates the practical benefits of quantum machine learning. Thus, there is a need for designing a QGNN solution that provides enhanced performance beyond classical GNNs.

Quantum machine learning based on parameterized quantum circuits is a new approach for harnessing practical benefits of near-term intermediate scale quantum computers. Ongoing studies have underscored that the effectiveness of quantum machine learning applications is strongly dependent on the ability to incorporate the intrinsic structure of the problem into a quantum model.

Quantum neural networks has mostly been used as an alias for parametric quantum circuits of layered structure used to process information encoded as quantum states. However, there is currently no consensus on the definition of a QGNN. In the present disclosure, a QGNN will be defined as a parameterized circuit with layered structures that are constructed according to the connections of the graph edges such that qubit registered representing node feature vectors are equivariant to graph automorphic transformations.

To this end, it would be advantageous to introduce a quantum machine learning framework based on QGNN to solve graph-classification problems since the QGNN framework may effectively capture the intrinsic symmetry of graph-related problems. Specifically, the present disclosure describes a QGNN framework defined as a parameterized quantum circuit that is configured for receiving inputs of data in the form of a graph, processing the data in a way that is compatible with the intrinsic graph symmetry of the data, and providing output about the properties of the graph. The QGNN architecture is composed of three major parts: a data encoding section, a message-passing section, and a readout section. Thus, the present disclosure describes a system and process that can effectively and efficiently solve graph based data-driven tasks using the QGNN framework.

As described herein, trapped atomic ions is an example of quantum information processing approach that has delivered fully programmable machines. In trapped ion QIP, interactions may be naturally realized as extensions of common two-qubit gate interactions. Therefore, it is desirable to use entangling gates for efficient (e.g., reduced gate count) quantum circuit constructions to implement interactions in trapped ion technology. One particular interaction available in the use of trapped ions for quantum computing is the so-called Mølmer-Sørensen (MS) gate, also known as the XX coupling or Ising gate. To achieve computational universality, the Mølmer-Sørensen gate (either locally addressable or globally addressable) is complemented by arbitrary single-qubit operations, for example.

Using these principles, the exemplary system and method described herein provides for implementing a QGNN framework for performing graph based data-driven tasks on a quantum circuit that has a plurality of qubits. In particular, the system and method includes obtaining data input in the format of a graph, processing the data in a way that is compatible with the intrinsic graph symmetry of the data, and providing output about the properties of the graph. By doing so, the QGNN framework can output information about global properties of the input graph or information about node-wise properties of the input graph.

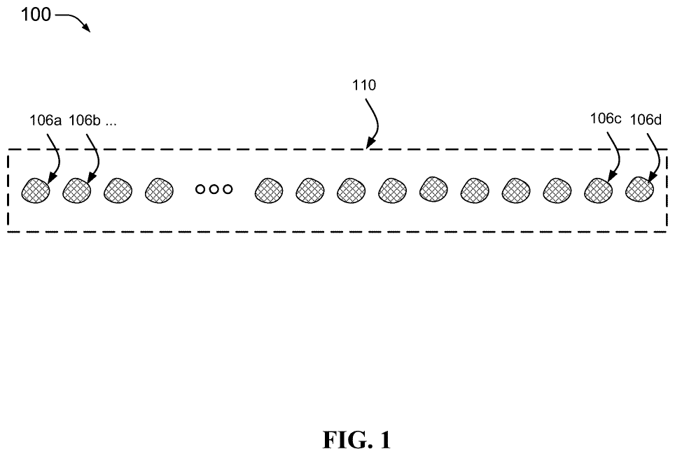

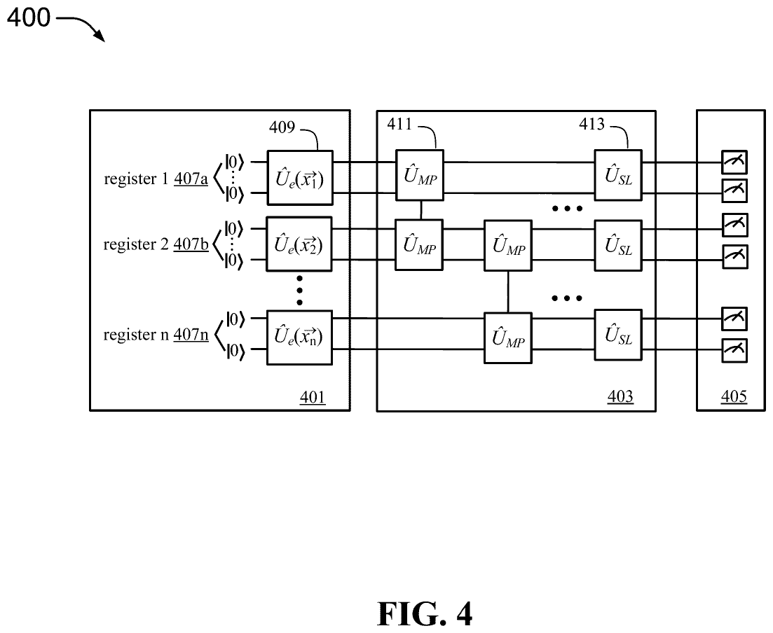

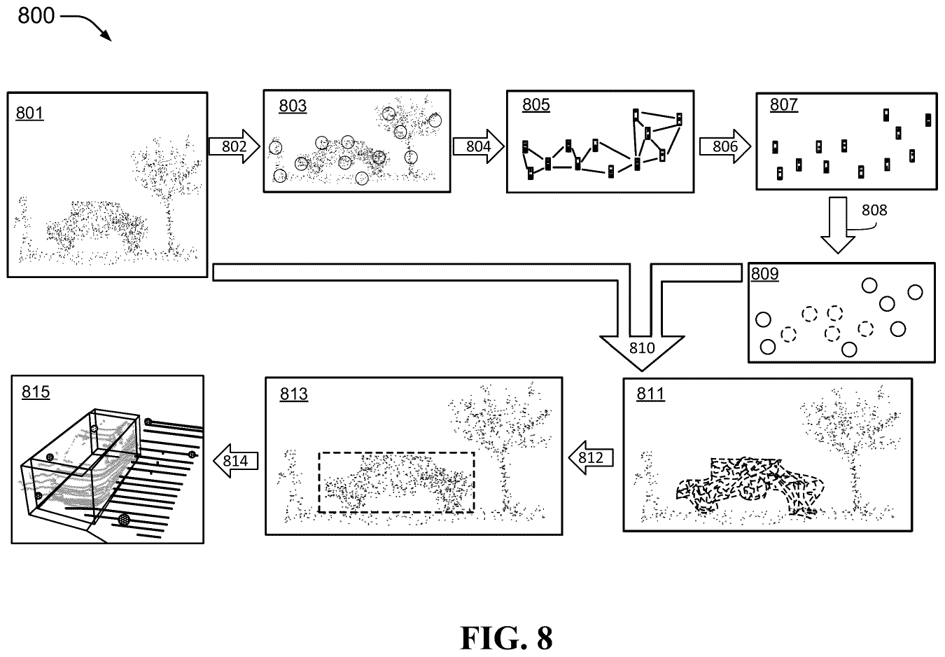

Solutions to the issues described above are explained in more detail in connection with FIGS. 1-10, with FIGS. 1-3 providing a general disclosure of QIP systems or quantum computers, and more specifically, of atomic based QIP systems or quantum computers, FIGS. 4-10 provide descriptions and examples of implementing and utilizing a QGNN framework to solve graph classification problems and FIGS. 8-10 provide descriptions and examples of implementing and utilizing the QGNN framework to transform three-dimensional (3D) point cloud data, in accordance with various example aspects of the present disclosure.

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

Atomic quantum computers can include array(s) of atoms or ions trapped, for example, inside a vacuum chamber. A size and dimensionality of atomic arrays may vary.

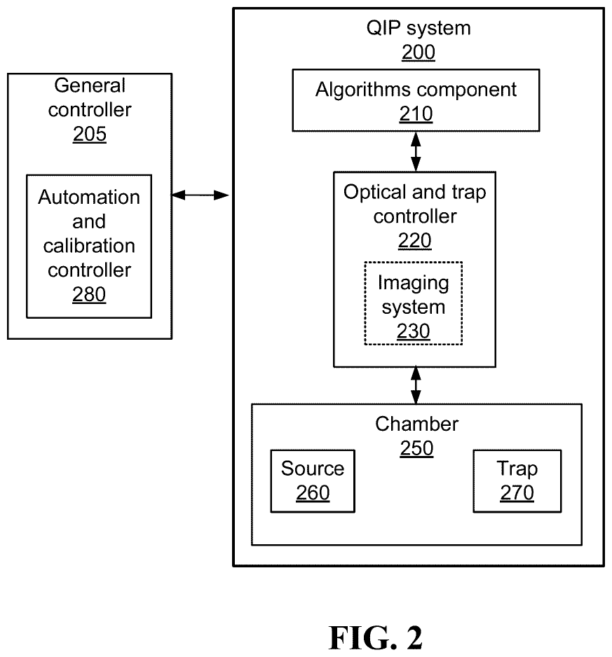

FIG. 1 illustrates a diagram 100 with multiple atomic ions or ions 106 (e.g., ions 106a, 106b, . . . , 106c, and 106d) trapped in a linear crystal or chain 110 using a trap (not shown; the trap can be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The ions 106 may be provided to the trap as atomic species for ionization and confinement into the chain 110. Some or all of the ions 106 may be configured to operate as qubits in a QIP system.

In the example shown in FIG. 1, the trap includes electrodes for trapping or confining multiple ions into the chain 110 laser-cooled to be nearly at rest. The number of ions trapped can be configurable and more or fewer ions may be trapped. The ions can be ytterbium ions (e.g., 171Yb+ ions), for example. The ions are illuminated with laser (optical) radiation tuned to a resonance in 171Yb+ and the fluorescence of the ions is imaged onto a camera or some other type of detection device (e.g., photomultiplier tube or PMT). In this example, ions may be separated by a few microns (m) from each other, although the separation may vary based on architectural configuration. The separation of the ions is determined by a balance between the external confinement force and Coulomb repulsion and does not need to be uniform. Moreover, in addition to ytterbium ions, barium ions, neutral atoms, Rydberg atoms, or other types of atomic-based qubit technologies may also be used. Moreover, ions of the same species, ions of different species, and/or different isotopes of ions may be used. The trap may be a linear RF Paul trap, but other types of confinement devices may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

The chain 110 of ions 106 may be part of a QPU, that is, the chain 110 of ions 106 may be part of a processing engine or processing core of a QIP system. When any one of the ions 106 is capable of being connected to any other ion 106 in the chain 110, the chain 110 is considered to be fully connected, and thus, it can be used to implement a fully connected QPU. Fully connected QPUs need not be limited to atomic-based QIP systems.

FIG. 2 illustrates a block diagram that shows an example of a QIP system 200. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations. The quantum and classical computations and operations may interact in such a hybrid system.

Shown in FIG. 2 is a general controller 205 configured to perform various control operations of the QIP system 200. These control operations may be performed by an operator, may be automated, or a combination of both. Instructions for at least some of the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200. These calibration, testing, and automation operations may involve, for example, all or part of an algorithms component 210, all or part of an optical and trap controller 220 and/or all or part of a chamber 250.

The QIP system 200 may include the algorithms component 210 mentioned above, which may operate with other parts of the QIP system 200 to perform or implement quantum algorithms, quantum applications, or quantum operations. The algorithms component 210 may be used to perform or implement a stack or sequence of combinations of single qubit operations and/or multi-qubit operations (e.g., two-qubit operations) as well as extended quantum computations. The algorithms component 210 may also include software tools (e.g., compilers) that facility such performance or implementation. As such, the algorithms component 210 may provide, directly or indirectly, instructions to various components of the QIP system 200 (e.g., to the optical and trap controller 220) to enable the performance or implementation of the quantum algorithms, quantum applications, or quantum operations. The algorithms component 210 may receive information resulting from the performance or implementation of the quantum algorithms, quantum applications, or quantum operations and may process the information and/or transfer the information to another component of the QIP system 200 or to another device (e.g., an external device connected to the QIP system 200) for further processing.

The QIP system 200 may include the optical and trap controller 220 mentioned above, which controls various aspects of a trap 270 in the chamber 250, including the generation of signals to control the trap 270. The optical and trap controller 220 may also control the operation of lasers, optical systems, and optical components that are used to provide the optical beams that interact with the atoms or ions in the trap. Optical systems that include multiple components may be referred to as optical assemblies. The optical beams are used to set up the ions, to perform or implement quantum algorithms, quantum applications, or quantum operations with the ions, and to read results from the ions. Control of the operations of laser, optical systems, and optical components may include dynamically changing operational parameters and/or configurations, including controlling positioning using motorized mounts or holders. When used to confine or trap ions, the trap 270 may be referred to as an ion trap. The trap 270, however, may also be used to trap neutral atoms, Rydberg atoms, and other types of atomic-based qubits. The lasers, optical systems, and optical components can be at least partially located in the optical and trap controller 220, an imaging system 230, and/or in the chamber 250.

The QIP system 200 may include the imaging system 230. The imaging system 230 may include a high-resolution imager (e.g., CCD camera) or other type of detection device (e.g., PMT) for monitoring the ions while they are being provided to the trap 270 and/or after they have been provided to the trap 270 (e.g., to read results). In an aspect, the imaging system 230 can be implemented separate from the optical and trap controller 220, however, the use of fluorescence to detect, identify, and label ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of what may be referred to as a processor or processing portion of the QIP system 200. That is, the trap 270 may be considered at the core of the processing operations of the QIP system 200 since it holds the atomic-based qubits that are used to perform or implement the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using one or more of the general controller 205, the automation and calibration controller 280, the optical and trap controller 220, and the chamber 250.

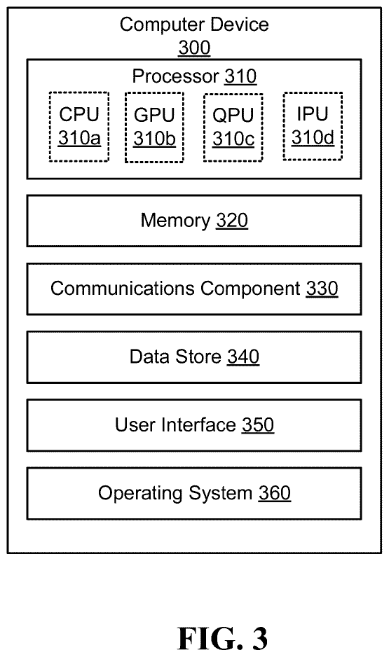

Referring now to FIG. 3, an example of a computer system or device 300 is shown. The computer device 300 may represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system configured to perform quantum computations and simulations is, for example, the QIP system 200 shown in FIG. 2.

The computer device 300 may include a processor 310 for carrying out processing functions associated with one or more of the features described herein. The processor 310 may include a single processor, multiple set of processors, or one or more multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300). Quantum operations may be performed by the QPUs 310c. Some or all of the QPUs 310c may use atomic-based qubits, however, it is possible that different QPUs are based on different qubit technologies. One or more of the QPUs 310c may be fully connected QPUs in accordance with aspects of this disclosure.

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In connection with the systems described in FIGS. 1-3, and with further details provided below, the present disclosure provides various aspects of techniques for quantum circuit design and configuration that accurately models scenarios in cognitive science that are known to violate assumptions from classical probability. As described in detail below, the system and method of an exemplary aspect designs/configures a quantum circuit that models known “interference effects” between mutually exclusive events whose outcome is not yet known, in such a way that an event that depends on these events is judged to be more or less likely than the classical law of total probability would allow.

In an exemplary aspect, the circuit design has four components: (1) a configuration to “set” the probability of a particular event (e.g., by rotating a coordinate frame to fix an angle between two pairs of axes), (2) a configuration to connect events saying that the outcome of a particular event may make an output of a subsequent event more or less likely, (3) a configuration to “entangle” events so that states representing different potential events can interfere with one another, including interference between incompatible outcomes, and (4) a configuration that “measures” events to model what happens when the system learns the outcome of one of the hitherto unknown events and to remove the possibility of other outcomes. The combination of such components according to the disclosed system and method accurately models disjunction interference effects from cognitive science.

In general, it should be appreciated that human judgements and choices can often defy rules they would be expected to follow if the processes followed the rules of classical probability. For example, the order in which questions are asked matters in ways that violate the classical notion that a conjunction is modeled by an intersection of fixed sets. Currently, order effects (i.e., the variation in the order in which questions are asked) can be accounted for using quantum probability as an alternative to classical probability. Quantum probability depends on comparing angles rather than volumes, and importantly, measuring a system causes it to “collapse” from a superposition of states, where the state is projected onto whichever pure state is observed, with a probability determined by the magnitude-squared of the projection output. Because projections do not commute with one another, the order of projections matters so the probability of different outcomes depends on the order of measurement.

According to an exemplary aspect, the system and method described herein is configured to create a quantum circuit for each question with a single qubit and a single gate that are configured to model one event (e.g., a single event) with two outcomes (e.g., A and not A=˜A), where a qubit in the quantum circuit is assigned to that event. Moreover, the system and method are configured to apply a single-qubit rotation to set the appropriate output probability. In other words, particular rotations and ranges can be defined by the quantum system (e.g., as described above for FIGS. 2 and 3 by applying lasers to the respective ions in the ion trap) for an angle θ defined the amount of X-rotation. In this aspect, an angle θ defines the probability of the particular event.

Thus, the systems and methods described herein are configured to implement a quantum circuit for addressing cognitive interference and can be executed on a gate-based quantum computer in an exemplary aspect. For example, a native gate set is a set of quantum gates that can be physically executed on hardware computing systems (e.g., FIGS. 2-3) by addressing ions (e.g., the exemplary ion chain in FIG. 1) with resonant lasers via stimulated Raman transitions. The angle θ can be defined by the amount of X-rotation where single-qubit gates can be rotated along different axes on a Bloch sphere and/or as rotations along a fixed axis while rotating the Bloch sphere itself. In an exemplary aspect, the rotations can be physically implemented as Rabi oscillations that are made with a two-photon Raman transition to drive the plurality of qubits, such as the ion chain shown in FIG. 1, for example, on resonance using a pair of lasers in a Raman configuration that can be implemented by the optical and trap controller 220, for example. Moreover, the ranges can be controlled by varying the duration of the laser pulses of the Raman configuration.

In connection with the systems described in FIGS. 1-3, a technique or method for implementing a QGNN framework that provides enhanced performance beyond classical GNNs is described. Specifically, the present disclosure describes a method and system for designing a QGNN framework on a quantum circuit to solve graph based-structured problems. The systems described in FIGS. 2 and/or 3 may be used to control various aspects of the QIP system as described below.

In some examples, the present disclosure describes a technique of designing a QGNN framework that is configured to incorporate graph symmetry of underlying problems. It is advantageous to use a QGNN to solve graph-related problems for several reasons. First, the QGNN is fully compatible with the general concept of quantum kernel advantage in quantum machine learning. Second, the QGNN allows an integration of complicated spatial/topological symmetry into the model, which is at the core of all machine learning algorithms. Third, QGNN is more expressive than its classical counter parts. Finally, QGNN has the potential to overcome the over-smoothing and over-squashing issue as evidenced in its classical counterpart.

Quantum kernel represents a very general heuristic approach for quantum variational algorithm design, which replaces at least one component of an otherwise pure classical algorithm with a variational quantum circuit. The reasoning behind the legitimacy of the quantum kernel approach relies on two key elements. First, the classical hardness of classically simulating the behavior of the algorithm with quantum components. In most cases, this hardness can be directly derived with the use of quantum variational ansatz that are known to be hard to simulate. Second, the existence of one problem, usually specifically constructed, that would otherwise not be solvable without the quantum components. Utility-wise, machine learning algorithms with quantum kernels have been shown to generalize better, train more efficiently with less data, and require smaller numbers of parameters. The exemplary aspects of the present disclosure shares the above-mentioned advantages as a special kind of quantum kernel.

Incorporating as much intrinsic symmetry of the problem at hand into a formulation of the model is one of the most important design principles. Approaches like convolutional neural networks and transformer models all owe a significant portion of their success to this principle of intrinsic symmetry. For example, by incorporating the translational and scaling invariance of images, the convolutional neural networks are able to reduce model complexity, reduce training costs, boost data efficiency, and improve generalization. The graph neural network formula (both classical and quantum) provides a generalized way to incorporate the symmetry of the space. On one hand, it allows a model to process topological information (e.g., understanding that donuts and coffee mugs are topologically the same). Such capacity is critical for data efficiency and generalization. On the other hand, for data like KITTI 3D point clouds, voxel-based approaches need to process many empty voxels. With GNNs, because the information aggregation naturally happens on a graph that defines the connection between regions, it naturally filters out empty spaces thus greatly enhancing the computational efficiency.

Since QGNN processes information using a convolutional-like information aggregation process (the message-passing), essentially only the message passing mechanism needs to be trained. In other words, a trained GNN can in principle be applied to graphs of arbitrary size, as long as the training data covers relevant information well. Together with the generalization power of QGNN as a variant of the quantum kernel, QGNN trained on small graphs may deliver inference results on larger graphs.

In classical message-passing GNN (MP GNN), it is known that information aggregation can be limited by a phenomenon known as “over-squashing.” “Over-squashing” occurs when information gets choked on one specific bottleneck. In practice, this is not uncommon because real-world graphs tend to form such bottlenecks. This is similar to how traffic congestion occurs on almost all road graphs. The “over-squashing” is also related to the issue of over-smoothing, which means that when the information is choked through aggregation, fine details are lost and the information on all nodes begin to converge and look similar. One practice to address “over-squashing”/over-smoothing is simply to increase the bandwidth by having a larger dimension node feature vector. However, this solution does not scale efficiently. With QGNN, the dimension of feature vector scales exponentially as the number of qubits per node, thus providing a solution to directly resolve the “over-squashing”/over-smoothing problem.

In the classical MP GNN, the information is stored on each node as node feature vectors. Then these graph neural network processes the feature vectors by flowing them through the edges. This is essentially what allows the GNN to be equivalent with respect to the graph automorphism transformation. This methodology is also used to implement the QGNN.

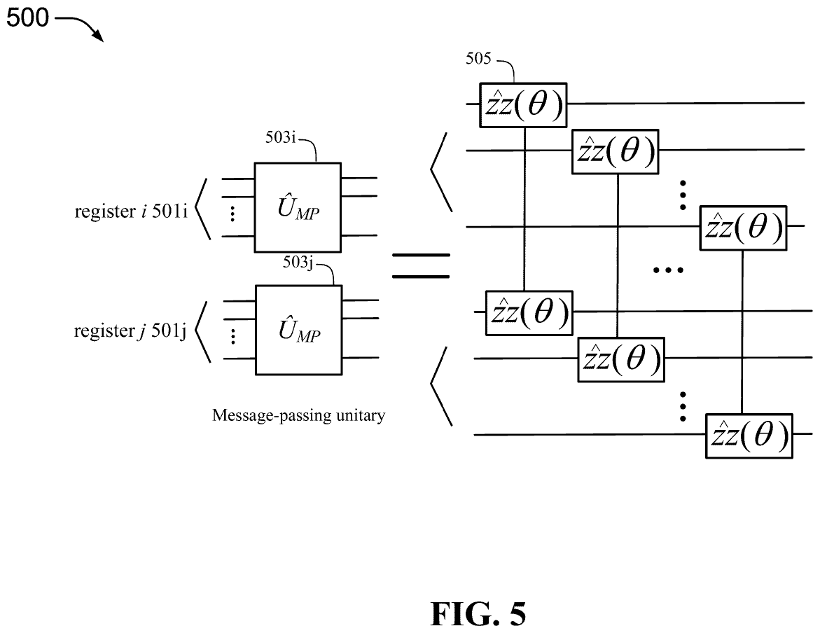

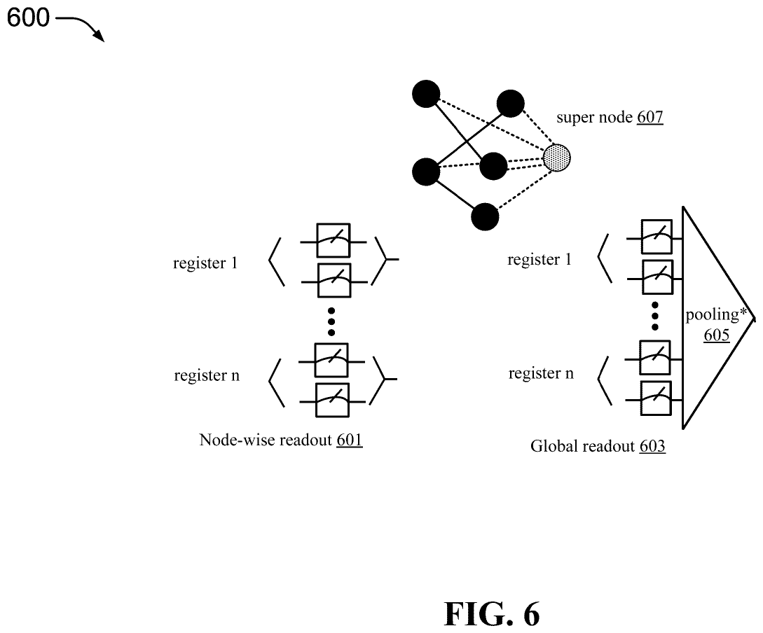

FIG. 4 illustrates an example of a design of a QGNN in accordance with aspects of this disclosure. As shown in FIG. 4, the QGNN is made up of three main components: a data encoding section 401, a message-passing section 403 (as will be explained in further detail in FIG. 5), and a readout section 405 (as will be explained in further detail in FIG. 6). Example 400 shows a QGNN implemented as a parameterized circuit with layered structures that are constructed according to the connections of the graph edges such that the qubit registers 407a, 407b, . . . 407n representing node feature vectors are equivariant to graph automorphic transformations.

As will be explained in more detail below, a whole chain of ions (e.g., the chain 110 of ions 106 as shown in FIG. 1) may be divided into groups corresponding to each qubit register representing nodes. The qubits in each register are then encoded with the corresponding node feature vectors. Entangling gates will be applied across pairs of registers as specified by the graph. Due to the all-to-all connectivity, there are no constraints on available pairs of gates. This means that the grouping and assignment of qubits into registers are arbitrary.

As shown in example 400, the present disclosure uses qubit registers according to the connections of the graph edges such that the qubit registers 407a represent node feature vectors of a graph. The data encoding section 401 uses encoding unitary Ûe(x^{→}i) 409 to encode each of the input node feature vector xi into corresponding register i. The message-passing section 403 is made up of I message passing layers made of message-passing unitaries Ü_{MP} 411 and self-loop unitaries Ü_{SL} 413. The readout section 405 performs standard qubit measurements in the computational basis and processes the shots according to the specific needs.

In order for the QGNN to be symmetric under the graph automorphism transformation, several constraints are applied in the design. First, Üₑ 409, and Ü_{SL} 413 are identically constructed across different qubit registers. In other words, they are constructed identically across all pairs of registered (e.g., referencing edge). Second, within each message-passing layer, message-passing unitaries Ü_{MP} 411 are to be applied identically to all pairs of registers whose corresponding graph vertices are connected by edges. Additionally, all Ü_{MP} 411 commute with each other within each message passing layer. Commute means that the order at which the message-passing unitaries are applied does not matter.

To process graph data with the QGNN, each input node feature vector is first encoded in quantum states on qubit registers 407a, 407b, . . . 407n in the data encoding section 401. A parameterized quantum circuit is then applied to transform the encoded quantum state according to the edge connectivity (as defined by graph edges) of the graph to naturally preserve the graph automorphic symmetry in the data encoding section 403. An edge connectivity of a graph is the minimum of the edge connectivity of every (ordered) pair of vertices in the graph. Finally, all the qubits are read out in a computational basis and then processed according to specific needs in the readout section 405.

Importantly, as compared with standard parameterized quantum circuits, the QGNN is not a circuit with a fixed structure. Instead, each input graph data is processed as a circuit generated on the fly according to the edges. In training, what gets optimized is the algorithm that generates circuits according to the data point instead of a fixed circuit.

### Data Encoding

The data encoding section is constructed according to a full permutation symmetry. In particular, this means that the same encoding operation is used for each register (e.g., reference to the graph edge connectivity).

As shown in example 400, each node feature vector is encoded into a quantum state with Üₑ(\vec{x}) 409. There may be different options for the encoding. As an example, example 400 uses lossless encodings such that Üₑ(\vec{x})=Üₑ(\vec{x}′) if and only if Üₑ(\vec{x})=Üₑ(\vec{x}′).

In principle, amplitude encoding with relative phases, which is configured for encoding 2ⁿ⁺¹−2 float values in a register of n qubits marks the upper bound for lossless encoding is considered. However, with Noisy Intermediate-Scale Quantum (NISQ) devices, reaching for such a limit may lead to huge cost in gate operations and, as a consequence, suffer in terms of performance. Certain approaches like matrix product stat encoding provide a good improvement, but at a cost of information loss.

For ease of implementation and NISQ compatibility, example 400 uses a variation of what is known as the product state encoding. To be specific, the feature vector of dimension 2n is encoded to each register of n qubits by applying

$${{\prod }_{i = 1}^{n} {R}_{x} ( \vec{{x}_{i}} ) {\prod }_{i = n + 1}^{2 n} {R}_{z} ( \vec{{x}_{i}} ) to \vert 0 〉}^{{⊗}_{n}} .$$

For a QGNN to be equivariant under graph automorphic transformation, all node registers 407a, 407b, . . . 407n must be treated equivalently. In the double sparse encoding scheme, this is satisfied because the encoding operator Üₑ 409 does not depend on the register indices. If variational encoding is used, it is important to note that the parameters should be shared among all the Üₑ applied to different registers.

### Quantum Message-Passing

FIG. 5 illustrates an example 500 of a message-passing unitary according to some implementations. Specifically, with symmetry considerations in mind, example 500 of FIG. 5 shows a simple design containing

$${\hat{U}}_{MP} ( i , j ) = {\prod }_{k = 1}^{n} {\hat{ZZ}}_{ik , jk} ( {θ}_{k} )$$

to construct Ü_{MP} 503i, 503j, where

$${\hat{ZZ}}_{a , b} ( θ ) = {e}^{i {θ}_{k} {\hat{σ}}_{a}^{( z )} {\hat{σ}}_{b}^{( z )}}$$

are standard Pauli-ZZ gates with variational parameters θ. Here σi(z) stands for Pauli-Z operator applied on qubit I 501i. In particular, ZZ(θ) 505 is applied to the k-th qubit of both registers 501i, 501j for all values of k. It should be noted that the variational parameters θ are different for different value of k.

After the registers 501i, 501j are encoded with the input node feature vectors, 1 quantum message-passing (MP) layers are applied to the registers 501i, 501j. Each MP layer is made of MP unitaries Ü_{MP} 503i, 503j and self-loop unitaries Ü_{SL}. Within each layer, for each undirected edge eᵢⱼ, Ü_{MP} is applied to register i 501i and register j 501j. This can be generally written as

$${\hat{U}}_{MP} ( i , j ) = {\prod }_{a = 1}^{n} {\prod }_{b = 1}^{n} {\hat{u}}_{ia , jb} .$$

Here, a and b iterate through all qubits in register i 501i and j 501j, respectively. ü_{ia,jb} may be any two-qubit gates.

Again, the quantum message-passing layers need to be equivariant under graph automorphism transformation. This leads to two symmetry considerations. First, the order in which Ü_{MP}(i,j) is applied artificial, which cannot have physical consequences on the results of the QGNN. In the classical GNN, this is naturally satisfied because the message coming from neighbors are summed up linearly. In this case, all the Ü_{MP}(i,j) must mutually commute with each other.

For directed edges, it is important to build in degrees of freedom to allow Ü_{MP,directed}(i,j)≠Ü_{MP,directed}(j,i). For undirected edges, each undirected edge may be treated as two counter-oriented directed edges and define Ü_{MP}(i,j)=Ü_{MP,directed}(i,j)Ü_{MP,directed}(j,i) given that Ü_{MP,directed}(j,i)'s commute with each other. This is conceptually identical to the symmetrization mentioned above, but with much less overhead. Alternatively, example 500 may ensure that Ü_{MP,directed}(i,j)=Ü_{MP,directed}(j,i).

In some examples, any two-body Pauli operator with an arbitrary angle may serve this purpose. In fact, such choices are equivalent when combined with Ü_{SL} that effectively also perform basis changes.

At the end of each MP layer, a self-loop unitary Ü_{SL} is applied. In the QGNN cases, Ü_{SL} achieves the purposes of both self-loop and local pool functions due to the standard parametric circuits ansatz being made of repeated layers of single qubit rotations and ZZ-gates are used. Again, to address symmetry concerns, all the Ü_{SL} applied to different registers are identical.

It is simple to verify that the design in example 500 satisfies all the above-mentioned symmetry constraints. Note that in specific “recurrent” design, all the 1 MP layers may be identical. But, this is not the case in the design in example 500. Instead, the same structure for all the machine layers is used and parameters are independently assigned to each layer.

### Readout

FIG. 6 illustrates an example 600 of a node-wise readout 601 or a global readout 603 according to some implementations. As shown in example 600 of FIG. 6, after the standard qubit readout in the computational basis, the shots are processed depending on whether global readout or node-wise readout is needed.

As a general matter, the readout schemes for GNN may be classified into two categories: (1) global readout 603 and (2) node-wise readout 601. Because global readout 603 and node-wise readout 601 pose different symmetry requirements, a choice of which readout should be made.

In global readout 603, all the shots are processed by a “pooling” process 605 that is register-permutation-invariant to form an output vector. This means that symmetries are not enforced within each qubit register. As an example of a global readout 603, for a molecule represented by a graph problem, the QGNN may provide information such as whether the molecule is toxic or not.

In node-wise readout 601, an output feature vector is generated by an identical process across registers, but the design of the process may be arbitrary. As an example of a node-wise readout 601, for a QGNN that provides information in a graph representing a traffic network, the QGNN may predict which node is likely to have a traffic jam.

In some examples, an artificial super node 607 is added to the graph to convert global readout 603 into node-wise readout 601. The artificial super node 607 is connected with all other nodes.

Global readouts 603 aim to derive a feature vector representing the global properties of the whole graph. This means that the readout scheme has to be invariant to graph automorphic transformation. Accordingly, since equivariant constraints is enforced in each stage of the QGNN, as long as the readout stage is invariant, the derived feature vector will be invariant. In addition, with most QPU, measurements are performed simultaneously on all qubits in computational basis. Thus, the readout design has two main considerations: (a) what observables should be estimated according to the computational basis measurements and (b) how should the estimation of the observables be processed into feature vectors?

For the first consideration, what are the observables that can be estimated efficiently from repeated computational basis measurements? In example 600, the choice is limited to the set {Z, I}^{⊗n}, as they can be naturally estimated from the computational basis measurement.

Based on this, the second consideration should be considered with the symmetrization technique commonly used in physics. To be specific, any observables o∈{Z,I}^{⊗n} should be symmeterized as

$$\tilde{o} = {\sum }_{\{ P ( \cdot ) ) \vert qubit permutations \}} P ( o ) ) .$$

It should be noted that symmetrization is performed with respect to the complete group of permutations so that the otherwise hard-to-identify automorphic symmetry of a graph is satisfied.

In practice, after the choices of symmetrized observables are organized into an output feature vectors [õ₁, õ₂, õ₃ . . . ] further classical enhancements may be applied with a shallow neural network. In some examples, the shallow neural network is always applied to enhance the output vector since it provides a significant improvement over not applying the shallow neural network. First, the classical enhancement with the shallow neural network is applied using a shallow multi-layer perception (MLP). The MLP is applied to each register identically to converse symmetry and to convert output feature vectors [õ₁, õ₂, õ₃ . . . ] into [õ₁′, õ₂′, õ₃′ . . . ] since classification tasks performed with [õ₁′, õ₂′, õ₃′ . . . ] are generally more accurate. To improve the training efficiency (e.g., how many times the quantum circuits need to be evaluated during training), the MLP and QGNN are trained separately in an iterative fashion (e.g., after every single optimization step for QGNN optimization (MLP fixed), many optimization steps for MLP (QGNN fixed) are performed). This is repeated until both the MLP and QGNN converge.

In addition, an artificial super node 607 may be added to convert global readout 603 into node-wise readouts 601. The artificial super node 607 has an edge connected to all the original nodes. In this way, via the MP layers, the artificial super node 607 can collect information across the whole graph and output a feature vector containing desired global information.

Node-wise feature vectors are equivariant to the graph automorphic transformation. Because the data encoding and quantum message passing parts are equivalent by design, all that is needed is to apply the same readout procedure to each node register.

For the readout of each node-wise register, the observables chosen from the set o∈{Z,I}^{⊗n} (may be estimated to form output node-wise feature vectors. Similar to the global readout, these node-wise feature vectors can then be enhanced by shallow classical neural networks. It should be noted that the choice of the observables, their arrangement in the feature vectors, as well as the subsequent shallow classical neural networks all have to be identical throughout different node registers to satisfy the equivariant requirement.

In some examples, the choice of observables to linear combinations of elements may be expanded to use the complete set of Pauli observables {X,Y,Z,I}^{⊗n}. In this case, the basis change should be performed so the desired observables can be measured effectively in the computation basis. The circuits needed to perform the basis transformation can be written in the form of the quantum message passing layers due to the graph symmetry constraint. Thus, this can be absorbed into the message passing layers and treated variationally.

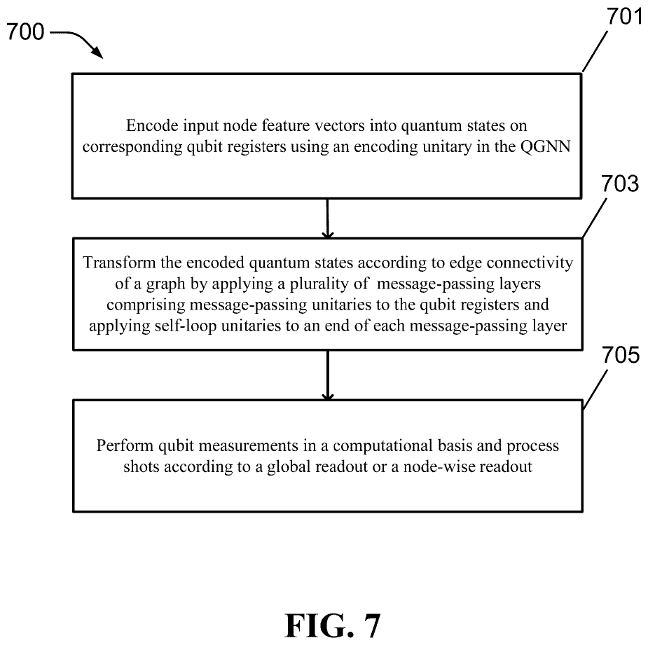

FIG. 7 illustrates a method of processing graph data with a QGNN framework in accordance with aspects of this disclosure. In general, it is noted that parts of the exemplary method 700 can be implemented using the components and systems described herein, especially with request to QIP system 200 and general controller 205 of FIG. 2 as described above. The steps and algorithms described in relation to method 700 may be executed by processor 310 using algorithms component 210. Specifically, the method 700 in FIG. 7 describes a method of transforming data in a graph format to be compatible with an intrinsic graph symmetry of the data.

At step 701, the method 700 may include encoding input node feature vectors into quantum states on corresponding qubit registers using an encoding unitary in a QGNN. The encoding section is constructed according to a full permutation symmetry. In particular this means that an identical procedure (e.g., encoding operation) is used to encode each node feature vector into its corresponding qubit registers. Since all the node feature vectors are encoded in an identical way, it is equivalent under any permutation, satisfying graph automorphic transformation/permutation (because graph automorphic permutation is a specific type of node permutation).

The QGNN may include layered structures constructed according to connections of graph edges such that the qubit registers configured to represent node feature vectors are treated equivalently and each input graph data is processed as a new circuit generated according to the graph edges. As an example, referring back to FIG. 4, the data encoding section 401 is configured to use encoding unitary Üe(x^{→}i) 409 to encode each of the input node feature vector xi into corresponding register i.

In some examples, the method 700 may further include storing information on each node as node feature vectors and processing the node feature vectors by iteratively processing the node feature vectors locally across and/or via the graph edges. This is a consequence of the message passing component being constructed according to the edge connectivity of each graph.

At step 703, the method 700 may include transforming the encoded quantum state according to edge connectivity of the graph by applying a plurality of message-passing layers comprising message-passing unitaries to the qubit registers and applying self-loop unitaries to an end of each message-passing layer. As an example, referring back to FIG. 4, the message-passing section 403 is made up of 1 message passing layers made of message-passing unitaries Ü_{MP} 411 and self-loop unitaries Ü_{SL} 413. The message-passing section 403 transforms the encoded quantum state according to the edge connectivity of the graph to naturally preserve the graph automorphic symmetry in the data encoding section 403.

In some examples, the encoding unitaries are identically constructed across different registers (e.g., pairs of qubit registers). As an example, referring back to FIG. 4, the encoding unitary 409 and the self-loop unitaries 413 are identically constructed across pairs of qubit registers. As another example, referring back to FIG. 5, a simple design is shown for Ü_{MP} 503i, 503j. In particular,

$${\hat{U}}_{MP} ( i , j ) = {\prod }_{k = 1}^{n} {\hat{ZZ}}_{ik , jk} ( {θ}_{k} ) ,$$

where

$${\hat{ZZ}}_{a , b} ( θ ) = {e}^{i {θ}_{k} {\hat{σ}}_{a}^{( z )} {\hat{σ}}_{b}^{( z )}}$$

are standard Pauli-ZZ gates with variational parameters θ.

In some examples, within each message-passing layer, the message-passing unitaries are applied identically to pairs of qubit registers whose corresponding graph vertices are connected by edges. In some examples, the message-passing unitaries are constructed using ZZ-gates.

In some examples, a self-loop unitary is added using a parametric circuits ansatz comprising repeated layers of single qubit rotations and ZZ-gates.

At step 705, the method 700 may include performing qubit measurements in a computational basis and processing shots according to a global readout or a node-wise readout. As an example, referring back to FIG. 4, the readout section 405 is configured to performs standard qubit measurements in the computational basis and processes the shots according to the specific needs.

In some examples, optionally, the method 700 may further include processing the shots based on a pooling process that is register-permutation-invariant to form an output vector when the shots are processed according to the global readout. As an example, referring back to FIG. 6, in a global readout 603, all the shots are processed by a “pooling” process 605 that is register-permutation-invariant to form an output vector.

In some examples, optionally, the method 700 may further include generating an output feature vector by an identical process across the qubit registers when the shots are processed according to the node-wise readout. As an example, referring back to FIG. 6, in a node-wise readout 601, an output feature vector is generated by an identical process across registers.

In some examples, optionally, the method 700 may further include connecting an artificial super node with all other nodes to the graph, wherein the artificial super node is configured to convert the global readout into the node-wise readout. As an example, referring back to FIG. 7, an artificial super node 607 is added to the graph to convert global readout 603 into node-wise readout 601 such that the artificial super node 607 is connected with all other nodes.

This disclosure provides a technique to solve graph-structured problems by implementing a QGNN that is configured to process and transform graph data in a way that is compatible with the intrinsic graph symmetry of the data and providing outputs about the properties of the graph. Specifically, the present disclosure describes that the output of the QGNN can provide information about either the global properties of the input graph or information about node-wise properties of the input graph. QGNN holds immense potential for unlocking quantum advantages, not only for tackling intrinsic graph problems but also for enhancing the topological processing efficacy of general learning problems.

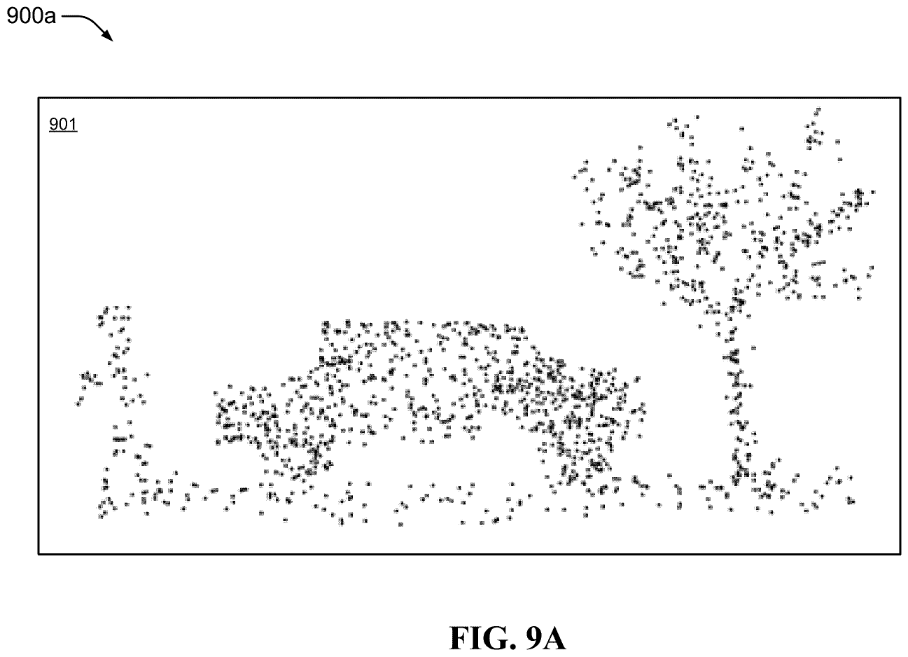

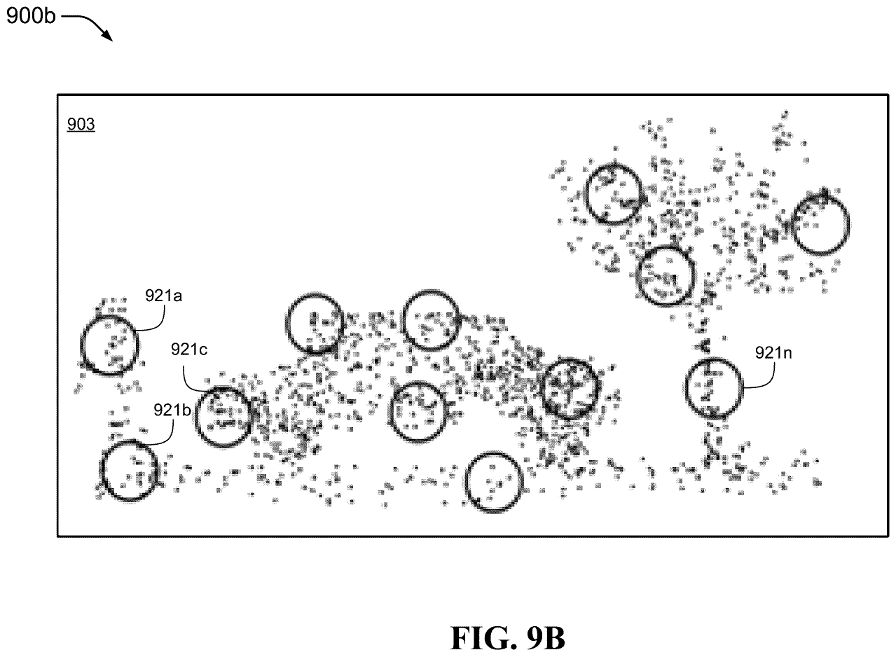

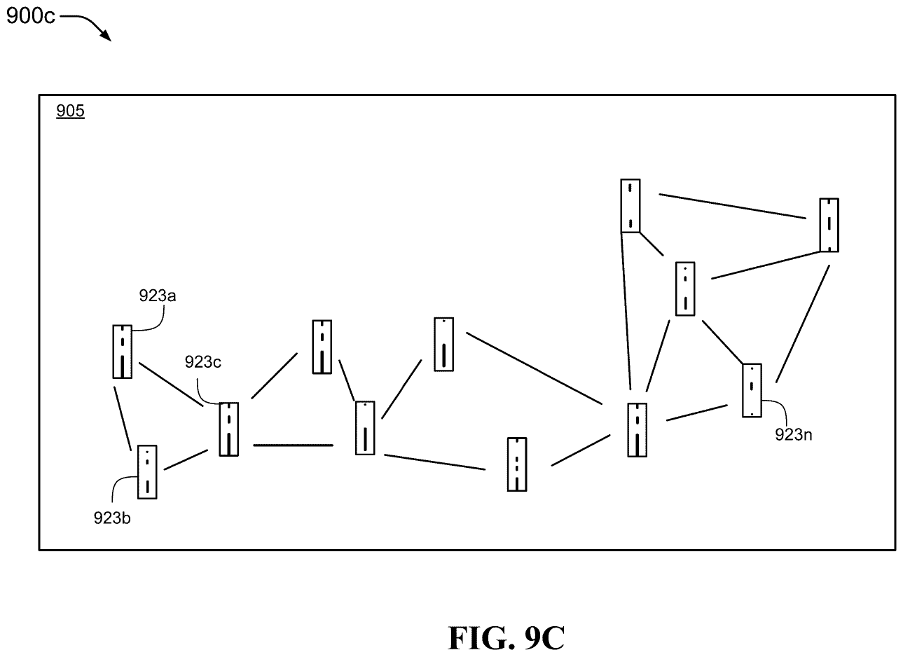

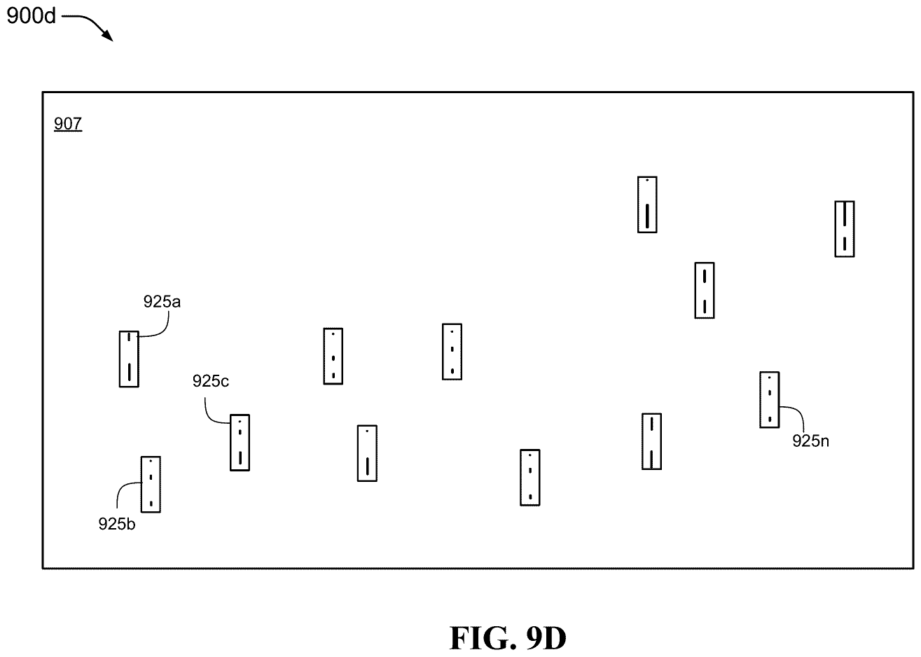

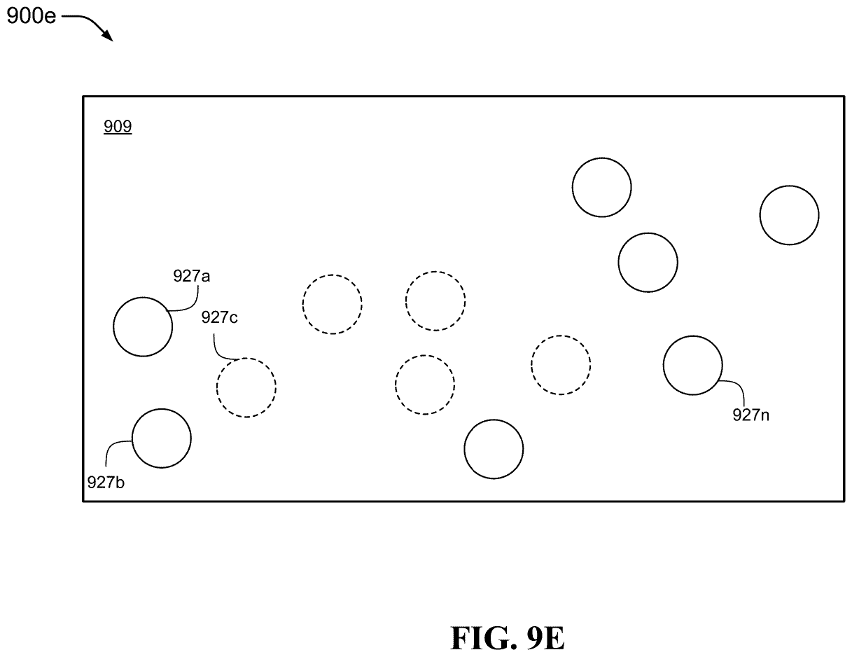

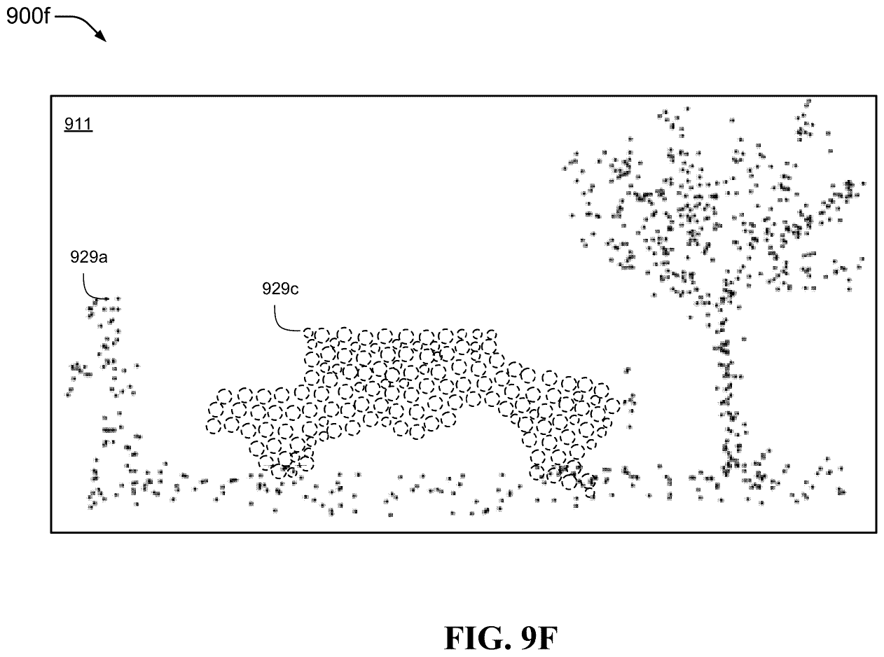

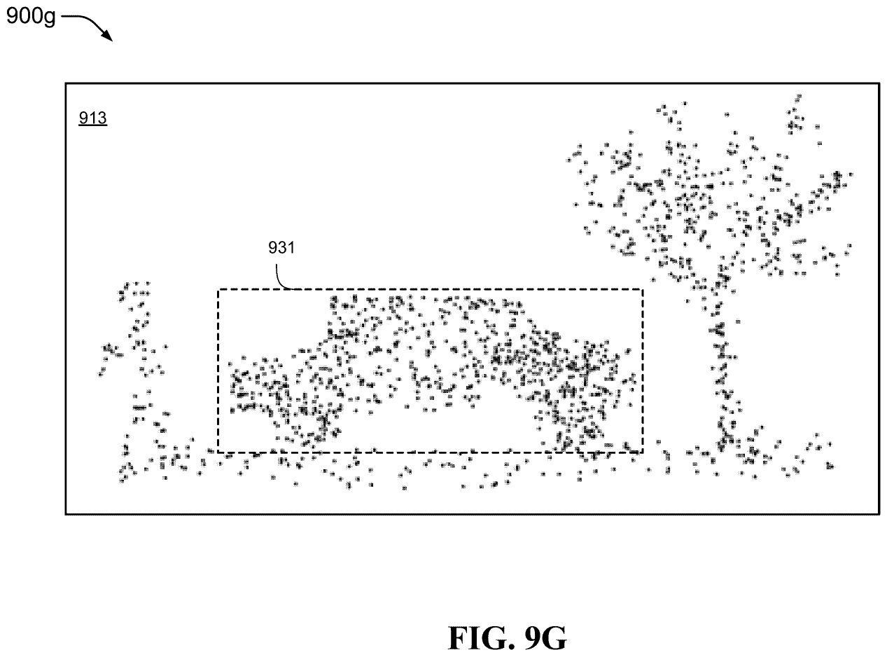

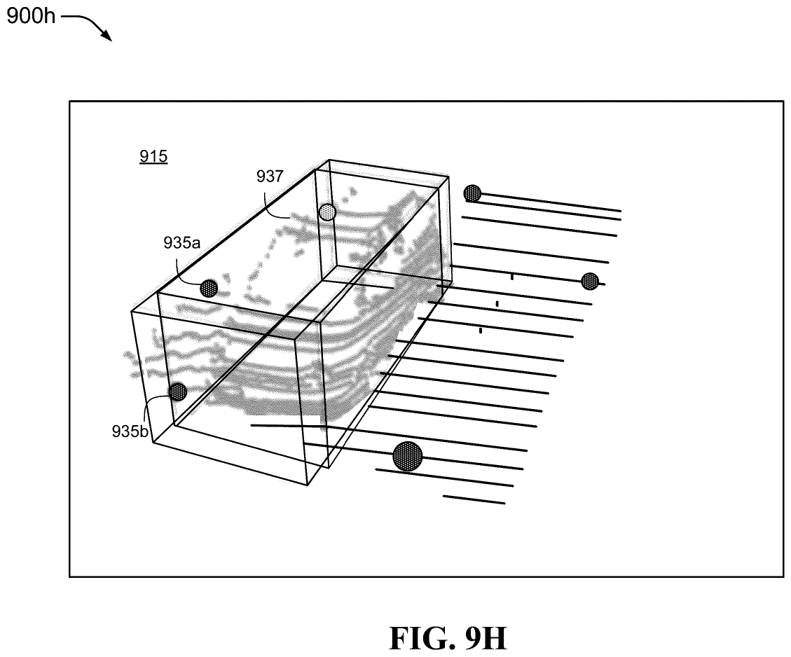

As shown in FIG. 8, the QGNN-based pipeline 800 begins by obtaining an original point cloud as shown in 801 (e.g., more details will be explained in FIG. 9A). At process 802, a sampling process is used to sample clusters as points as shown in 803 (e.g., more details will be explained in FIG. 9B). At process 804, a pre-processor aggregates each of the points included in each cluster independently into a feature vector. A graph may be formed using the clusters as shown in 805 (e.g., more details will be explained in FIG. 9C). Each node may contain two pieces of information: the original center coordinate of the cluster and the feature vector generated by the pre-processor. The edges are then connected among all the nodes within a given Euclidean distance. At process 806, the graph is processed by QGNN into node-wise feature vectors as shown in 807 (e.g., more details will be explained in FIG. 9D). At process 808, another post-processor infers the property of each output node-wise feature vector to determine the property of the local region and decide whether the node-wise feature vector is “on the target” or “not on the target” as shown in 809 (e.g., more details will be explained in FIG. 9E). At process 810, a region proposal is used in a selection algorithm at 811 to pick a larger cluster of points from the original point cloud as shown in 801 (e.g., more details will be explained in FIG. 9F). At process 812, a bounding box regression algorithm may predict the bounding box as shown in 813 (e.g., more details will be explained in FIG. 9G). At process 814, a 3D rendering of point clouds from a dataset is generated with key points and bounding boxes identified by the pipeline at 815 (e.g., more details will be explained in FIG. 9H). In some examples, the dataset may be a Karlsruhe Institute of Technology and Toyota Technological Institute at Chicago (KITTI) dataset, which is a collection of images and LIDAR data used in computer vision research such as stereo vision, optical flow, visual odometry, 3D object detection, and 3D tracking.

FIG. 9A illustrates a schematic diagram of an original point cloud. A point cloud is a discrete set of data points that represent a 3D shape or objects in space. The points represent an X, Y, and Z geometric coordinates of a single point on an underlying sampled surface. Point clouds are a means of collating a large number of single spatial measurements into a dataset that can then represent a whole. In many cases, points clouds are most commonly generated using 3D laser scanners and LiDAR technology where each point represents a single laser scan measurement.

As shown in example 900a of FIG. 9A, the first step of the QGNN-based pipeline is to down-sample the original point cloud 901. In some examples, the original point cloud 901 can be sampled by sampling a set of key points using a furthest point sampling (FPS). In particular, the FPS algorithm itself iteratively adds new points one-by-one into the key-point set. The point selected at each time has the furthest distance from all the already-selected points. A cluster is then formed of radios r_{c} around key points. In this way, points within distance r_{c} of a selected key point is added into the corresponding cluster.

FIG. 9B illustrates a schematic diagram of sampling clusters of points. As shown in example 900b of FIG. 9B, clusters 921a, 921b, 921c, . . . 921n are formed from sample the original point cloud 900a from FIG. 9A.

In some examples, the proper size for clusters 921a, 921b, 921c, . . . 921n, as defined by r_{c}, may be chosen. In some example, the size for the clusters may correspond to roughly the same size as simple geometric objects (e.g., a tire). In addition, a longest distance between connected nodes or graphs may be set to be roughly the size of an object of interest (e.g., a car) so the clusters connected by edges are correlated.

FIG. 9C illustrates a schematic diagram of graph data formed using sampled clusters of points. As shown in example 900c of FIG. 9C, an input graph of the QGNN 905 is created based on the obtained clusters 921a, 921b, 921c, . . . 921n after completion of the pre-process steps shown in FIGS. 9A-9B. Each of the obtained clusters 921a, 921b, 921c, . . . 921n are processed into a feature vector 923a, 923b, 923c, . . . 923n of specified dimensions. Each vertex of the graph corresponds to a cluster. In some examples, the clusters are processed into feature vectors using a quantum version of PointNet. In some examples, the clusters are processed into feature vectors using a classical version of PointNet. These feature vectors are used as the vertex feature vector of the input graph. In some examples, the edge, or connections, of the graph may be determined by the Euclidean distance between the key points at the center of each cluster.

PointNet is unified architecture for applications ranging from object classification, part segmentation, to semantic parsing. PointNet directly takes point clouds as input and outputs either class labels for the entire input or per point segment/part labels for each point of the input.

FIG. 9D illustrates a schematic diagram of node-wise feature vectors generated from the graph data. As shown in example 900d of FIG. 9D, the input graph 907 is then processed by the QGNN (as shown above in FIGS. 4-7). In particular, the node feature vectors 923a, 923b, 923c, . . . 923n are embedded on the registers and then processed by the quantum message passing circuit (message-passing section 403 as shown in FIG. 4). In particular, the readout portion of the QGNN (read-out section 405 as shown in FIG. 4) is performed to detect all the qubits and to collect the statistics of all binary bit strings representing all the readout shots. The shots are then processed into global or nodewise feature vectors 925a, 925b, 925c, . . . 925n as shown in 907.

In some examples, the size of node feature vectors 925a, 925b, 925c, . . . 925n must also be chosen. A larger node feature vector may lead to a higher inference accuracy, but will also require more qubits to encode the entries of each node feature vector. With a limited number of qubits, this means the number of nodes the QGNN can process in a graph is also less.

In some case, the node-wise feature vectors obtained for each vertex are then processed by a single linear classifier, [symbol] =x A^{T}+b, into the label of the cluster. In the context of object detection, this step is similar to region proposal generation because it generates information about the location of target objects.

In generic applications, the global or nodewise feature vectors 925a, 925b, 925c, . . . 925n may be input into other image-task procedures for any purpose. In some examples, given enough qubits and gates, it is possible to directly generate the bounding box prediction at each node as shown in 900g of FIG. 9G.

FIG. 9E illustrates a schematic diagram of determining whether a property of each output node-wise feature vector is on a target object or not. As shown in example 900e of FIG. 9E, the pipeline may include limiting the QGNN to identifying which key points are on target objects (e.g., cars). The key points that are on target objects may be indicated by a dashed circle while the key points that are not on the target objects may be indicated by a solid line. To perform bounding box prediction, an extra bounding box prediction pipeline may be used.

The first step of the bounding box prediction pipeline is selecting clusters of points from the original point cloud 901 around the key points positively identified as on-the-target objects (e.g., target clusters) 927c. These target clusters 903 may include more points than compared to those in example 900b because now the properties according to the global property of the car is to be predicted, while in example 900b, only the local information is used. This allows a larger portion of the picked points to be on the car and lead to better bounding box prediction accuracy.

In some examples, algorithms such as diffusion may be used to pick points around the positively identified key points. This way a larger portion of the picked points may be on the target and potentially lead to better bounding box prediction accuracy.

As shown in example 900e, points within a fixed radius of the key points 927a, 927b, 927c, . . . 927n are selected to form the target clusters. In some examples, each target cluster may be processed using a PointNet module that is constructed using classical components, or with quantum enhancements. In some examples, a classical PointNet may be implemented as a GNN and is referred to as a Bounding Box PointNet (BBPN). It should be noted that the BBPN can and should be trained independently instead of being trained with all other parts of the pipeline because training data and label can be efficiently generated from the dataset.

In some examples, the dataset corresponds to a KITTI dataset. The KITTI dataset is a popular dataset for use in mobile robotics and autonomous driving. It consists of hours of traffic scenarios recorded with a variety of sensor modalities, including high-resolution RGB, grayscale stereo cameras, and a 3D laser scanner. It should be noted that the dataset itself does not contain ground truth for semantic segmentation. However, users may manually annotate parts of the dataset to fit their own needs.

In some examples, the complete KITTI dataset frames may need to be cropped into smaller point cloud frames so they can be processed in a single graph due to the size constraints and limited number of qubits. In some examples, small “boxes” of point clouds may be cropped around the bounding boxers of objects given in the labels to create a downsized dataset for training and testing. The labels of the cropped point cloud may be derived from the KITTI dataset according to bounding boxes. The area of cropping may be cropped to be the size of the bounding boxes (e.g., from the label) expanded by an expansion ratio. The expansion ratio may be a factor that has a strong impact on the model performance because the MP formalism uses only relative position and is compatible with graphs of arbitrary structure and size. The impact of cropping methods on the model performance may be related to the label quality and the diversity of objects that appear in the frame. For example, when the cropping area is too small, it may only include a car and a background floor. In this case, the trained model will generalize poorly because all the models need to learn is to label everything above the floor as a car.

In some examples, a filter for the number of points in each cut-out frame is set so they are all within a specific range. This allows the sampling algorithm with a specified sample ratio to generate clusters of similar density, which will improve the training efficacy.

In some examples, the original KITTI dataset may be processed to generate cropped frames of different sizes. In some examples, the approach may contain two parts: a graph generation part that samples clusters from the cloud and then uses PointNet to process each cluster into a feature vector. Then, a QGNN part processes these clusters using quantum message passing.

FIG. 9F illustrates a schematic diagram of picking a larger cluster of points from the original point cloud. As shown in example 900f, the post-processor infers the property of each output node-wise feature vector to determine the property of the local region and then decide whether the output node-wise feature vector is “on-the-target” 929c or “not on-the-target” 929a. The region proposal is then used in a selection algorithm to pick a larger cluster of points from the original point cloud as shown in 911.

FIG. 9G illustrates a schematic diagram of predicting a bounding box in 929c. As shown in example 900g, a bounding box regression algorithm then predicts the bounding box 931 as shown in 913.

FIG. 9H illustrates a schematic diagram of generating a 3D rendering of point clouds from a data set with key points and bounding boxes. As shown in example 900h, a 3D rendering of point clouds 915 is rendered from a dataset with key points 935a, 935b and bounding boxes 937 identified by the QGNN pipeline.

In some examples, the QGNN pipeline is used to process real-world KITTI 3D point cloud datasets using both numerical simulation and a quantum computing system (e.g., see FIGS. 1-2). As a non-limiting example, the quantum computing system may support up to 32 physical qubits made of Ytterbium ions.

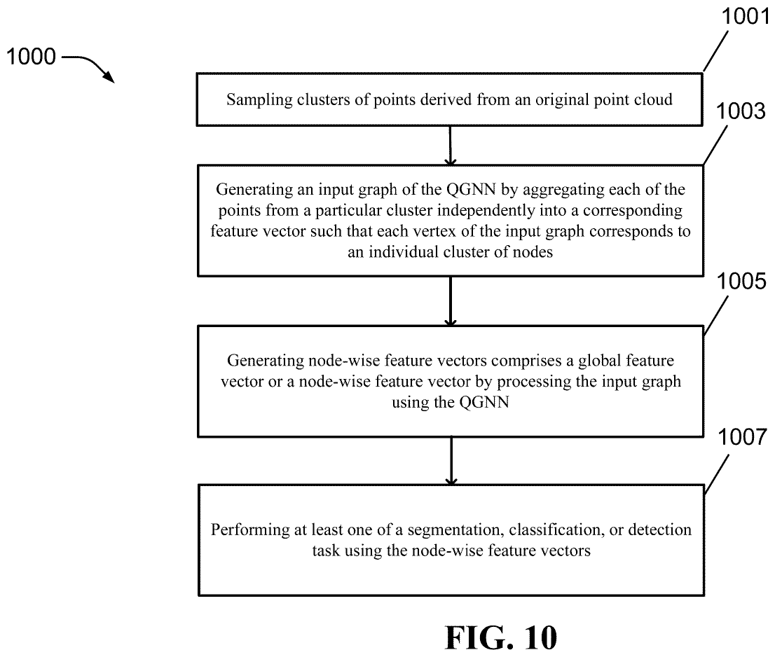

FIG. 10 illustrates a method of using a quantum graph neural network (QGNN) for processing three-dimensional (3D) point cloud data. In general, it is noted that parts of the exemplary method 1000 can be implemented using the components and systems described herein, especially with request to QIP system 200 and general controller 205 of FIG. 2 as described above. The steps and algorithms described in relation to method 1000 may be executed by processor 310 using algorithms component 210. Specifically, the method 1000 in FIG. 7 describes a method of using a QGNN for processing 3D point cloud data.

At block 1001, the method 1000 includes sampling clusters of points derived from an original point cloud.

As an example, referring back to FIG. 8, the QGNN-based pipeline 800 begins by obtaining an original point cloud as shown in 801. As another example, referring back to example 900a of FIG. 9A, the first step of the QGNN-based pipeline is to down-sample the original point cloud 901.

At block 1003, the method 1000 includes generating an input graph of the QGNN by aggregating each of the points from a particular cluster independently into a corresponding feature vector such that each vertex of the input graph corresponds to an individual cluster of nodes. Each node may include an original center coordinate of a local cluster and a feature vector. Feature vectors may correspond to vertex feature vectors of the input graph.

As an example, referring back to FIG. 8, a sampling process is used to sample clusters as points as shown in 803. As another example, referring back to example 900b of FIG. 9B, clusters 921a, 921b, 921c, . . . 921n are formed from sample the original point cloud 900a from FIG. 9A.

At block 1005, the method 1000 includes generating node-wise feature vectors comprising a global feature vector or a node-wise feature vector by processing the input graph using the QGNN. The node-wise feature vectors of each vertices may represent a property of a local cluster. In some examples, the node-wise feature vectors of each node contains processed information that reveals property of a corresponding local cluster.

As an example, referring back to FIG. 8, at process 804, a pre-processor aggregates all points included in each cluster collectively into a feature vector. As another example, referring back to the example 900c of FIG. 9C, an input graph of the QGNN 905 is created based on the obtained clusters 921a, 921b, 921c, . . . 921n after completion of the pre-process steps shown in FIGS. 9A-9B. Each of the obtained clusters 921a, 921b, 921c, . . . 921n are processed into a feature vector 923a, 923b, 923c, . . . 923n of specified dimensions.

In this pre-processing step, it is clear that the resulting node (vertex) feature vectors consist of two components—the cluster center coordinate and the cluster feature vector. However, the QGNN is agnostic to all of this. Instead, all the QGNN cares about is that it has an input feature vector made of features. It should be noted that this may be different from the design of some classical GNN, which treats the coordinate component and the feature component differently.

At block 1007, the method 1000 includes performing at least one of a segmentation, classification or detection task using the node-wise feature vectors.

In some examples, the method 1000 further includes inferring a property of each output node-wise feature vector to determine a property of a local region; and determining whether the local region is on a target object or not on a target object.

As an example, referring back to FIG. 8, at process 808, another post-processor may infer the property of each output node-wise feature vector to determine the property of the local region and decide whether the node-wise feature vector is “on the target” or “not on the target” as shown in 809. As another example, referring back to FIG. 9E, the first step of the bounding box prediction pipeline is selecting clusters of points from the original point cloud 901 around the key points positively identified as on-the-target objects (e.g., target clusters) 927c. These target clusters may include more points than compared to those in example 900b because now the properties according to the global property of the car is to be predicted, while in example 900b, only the local information is used.

In some examples, the method 1000 may further include determining a second cluster of points from the original point cloud using a selection algorithm on a proposed region, predicting a bounding box on the proposed region, and generating a 3D rendering of point clouds from a dataset with key points on the bounding box. The second cluster is larger than the clusters sampled for pre-processing. In some examples, predicting the bounding box on the proposed region may be predicted using a bounding box regression algorithm. In some examples, the method 1000 may further include generating a bounding box prediction at each node. In some examples, the dataset may correspond to a KITTI dataset.

As an example, referring back to FIG. 8, at process 810, a region proposal is used in a selection algorithm at 811 to pick a larger cluster of points from the original point cloud as shown in 801. As another example, referring back to FIG. 9F, as shown in example 900f, the post-processor infers the property of each output node-wise feature vector to determine the property of the local region and then decide whether the output node-wise feature vector is “on-the-target” 929c or “not on-the-target” 929a.

The proposed region may be a new region determined from all of the “local regions” determined above. The local property of each region is determined according to the output feature vector of QGNN. The method 1000 then decides how to take the second cluster. For example, if there are three local regions next to each other all categorized as “on-the-target,” then the method 1000 may take a large area that includes all three local regions to form the new clusters for the following tasks.

In some examples, the method 1000 may include generating a 3D rendering of point clouds from a dataset with key points and the bounding box.

As an example, referring back to FIG. 8, at process 814, a 3D rendering of point clouds from a dataset is generated with key points and bounding boxes identified by the pipeline at 815. As another example, referring back FIG. 9H, as shown in example 900h, a 3D rendering of point clouds 915 is rendered from a dataset with key points 935a, 935b and bounding boxes 937 identified by the QGNN pipeline.

In some examples, the method 1000 may include sampling a set of key points from the original point cloud using a furthest point sampling (FPS). As an example, referring back to example 900a of FIG. 9A, the original point cloud 901 can be sampled by sampling a set of key points using a furthest point sampling (FPS). In particular, the FPS algorithm itself iteratively adds new points one-by-one into the key-point set.

In some examples, the method 1000 may include connecting edges of the input graph according to a Euclidean distance between the key points at the center of each cluster. In some examples, the method 1000 may include performing pre-processing on each cluster to create feature vectors of a specified dimension for the key points. In some examples, the pre-processing may be performed using classical computing. In some examples, the clusters are processed into feature vectors using a classical version of PointNet. In some examples, the pre-processing may be performed using quantum computing. In some examples, the clusters are processed into feature vectors using a quantum version of PointNet.

In some examples, the method may further include: processing the input graph using the QGNN by: encoding input node feature vectors from the input graph into quantum states on corresponding qubit registers using an encoding unitary in the QGNN, transforming the encoded quantum state according to edge connectivity of the graph by applying a plurality of message-passing layers comprising message-passing unitaries to the qubit registers and applying self-loop unitaries to an end of each message-passing layer, wherein the QGNN comprises layered structures constructed according to connections of graph edges such that the qubit registers configured to represent node feature vectors are treated equivalently and each input graph data is processed as a new circuit generated according to the graph edges, and performing qubit measurements in a computational basis and processing shots according to a global readout or a node-wise readout. This process is described in further detail in method 700 of FIG. 7.

In some examples, the method 1000 may further include identifying, using the QGNN, which key points are on a target object; and performing a bounding box prediction using a bounding box prediction pipeline. As an example, referring back to example 900e of FIG. 9E, points 909 within a fixed radius of the key points 927a, 927b, 927c, . . . 927n are selected to form the target clusters. In some examples, each target cluster may be processed using a PointNet module that is constructed using classical components, or with quantum enhancements.

This disclosure provides a technique to use a QGNN for processing 3D point cloud data. Specifically, the present disclosure describes how a QGNN may be used in a full 3D point cloud-based objection detection pipeline. In particular, the full QGNN pipeline combines the QGNN node-wise classification (e.g., effectively region proposal) with a separately trained bounding box PointNet. QGNN holds immense potential for unlocking quantum advantages, not only for tackling intrinsic graph problems but also for enhancing the topological processing efficacy of general learning problems.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of using a quantum graph neural network (QGNN) for transforming three-dimensional (3D) point cloud data, comprising:
sampling clusters of points derived from an original point cloud;
generating an input graph of the QGNN by aggregating each of the points from a particular cluster independently into a corresponding feature vector such that each vertex of the input graph corresponds to an individual cluster of nodes, wherein each node comprises an original center coordinate of a local cluster and a feature vector, wherein feature vectors correspond to vertex feature vectors of the input graph;
generating node-wise feature vectors comprises a global feature vector or a node-wise feature vector by processing the input graph using the QGNN, wherein the node-wise feature vectors of each vertices represents a property of a local cluster; and
performing at least one of a segmentation, classification or detection task using the node-wise feature vectors.

2. The method of claim 1, further comprising:
inferring a property of each node-wise feature vector to determine a property of a local region, wherein the node-wise feature vectors comprise processed information revealing property of a corresponding local cluster; and
determining whether the local region is on a target object or not on a target object.

3. The method of claim 2, further comprising:
determining a second cluster of points from the original point cloud using a selection algorithm on a proposed region, wherein the second cluster is larger than the clusters sampled for pre-processing;
predicting a bounding box of the proposed region; and
generating a 3D rendering of point clouds from a dataset with key points and the bounding box.

4. The method of claim 1, further comprising:
generating a bounding box prediction at each node.

5. The method of claim 4, further comprising:
generating a 3D rendering of point clouds from a dataset with key points and the bounding box.

6. The method of claim 1, further comprising:
sampling a set of key points from the original point cloud using a furthest point sampling (FPS).

7. The method of claim 6, further comprising:
connecting edges of the input graph according to a Euclidean distance between the key points at the center of each cluster.

8. The method of claim 7, further comprising:
performing pre-processing on each cluster to create feature vectors of a specified dimension for the key points.

9. The method of claim 1, further comprising:
processing the input graph using the QGNN by:
encoding input node feature vectors from the input graph into quantum states on corresponding qubit registers using an encoding unitary in the QGNN,
transforming the encoded quantum state according to edge connectivity of the graph by applying a plurality of message-passing layers comprising message-passing unitaries to the qubit registers and applying self-loop unitaries to an end of each message-passing layer, wherein the QGNN comprises layered structures constructed according to connections of graph edges such that the qubit registers configured to represent node feature vectors are treated equivalently and each input graph data is processed as a new circuit generated according to the graph edges, and
performing qubit measurements in a computational basis and processing shots according to a global readout or a node-wise readout.

10. The method of claim 1, further comprising:
identifying, using the QGNN, which key points are on a target object; and
performing a bounding box prediction using a bounding box prediction pipeline.

11. A system of transforming three-dimensional (3D) point cloud data using a quantum graph neural network (QGNN), comprising:
a pre-processor configured to:
sample clusters of points derived from an original point cloud, and
generate an input graph of the QGNN by aggregating each of the points from a particular cluster independently into a corresponding feature vector such that each vertex of the input graph corresponds to an individual cluster of nodes, wherein each node comprises an original center coordinate of a local cluster and a feature vector, wherein feature vectors correspond to vertex feature vectors of the input graph;
a QGNN configured to: generate node-wise feature vectors comprises a global feature vector or a node-wise feature vector by processing the input graph with the QGNN, wherein the node-wise feature vectors of each vertices represents a property of a local cluster; and
a post-processor configured to perform at least one segmentation, classification or detection task using the node-wise feature vectors.

12. The system of claim 11, wherein the post-processor is further configured to:
infer a property of each node-wise feature vector to determine a property of a local region, wherein node-wise feature vectors comprise processed information revealing property of a corresponding local cluster; and
determine whether the local region is on a target object or not on a target object.

13. The system of claim 12, wherein the post-processor is further configured to:
determine a second cluster of points from the original point cloud using a selection algorithm on a proposed region, wherein the second cluster is larger than the clusters sampled for pre-processing;
predict a bounding box of the proposed region using a bounding box regression algorithm; and
generate a 3D rendering of point clouds from a dataset with key points and the bounding box.

14. The system of claim 11, wherein the post-processor is further configured to:
generate a bounding box prediction at each node.

15. The system of claim 14, wherein the post-processor is further configured to:
generate a 3D rendering of point clouds from a dataset with key points and the bounding box.

16. The system of claim 11, wherein the pre-processor is further configured to:
sample a set of key points from the original point cloud using a furthest point sampling (FPS).

17. The system of claim 16, wherein the pre-processor is further configured to:
connect edges of the input graph according to a Euclidean distance between the key points at the center of each cluster.

18. The system of claim 17, wherein the pre-processor is further configured to:
perform pre-processing on each cluster to create feature vectors of a specified dimension for the key points.

19. The system of claim 11, wherein the QGNN is further configured to:
encode input node feature vectors from the input graph into quantum states on corresponding qubit registers using an encoding unitary in the QGNN,
transform the encoded quantum state according to edge connectivity of the graph by applying a plurality of message-passing layers comprising message-passing unitaries to the qubit registers and applying self-loop unitaries to an end of each message-passing layer, wherein the QGNN comprises layered structures constructed according to connections of graph edges such that the qubit registers configured to represent node feature vectors are treated equivalently and each input graph data is processed as a new circuit generated according to the graph edges, and
perform qubit measurements in a computational basis and processing shots according to a global readout or a node-wise readout.

20. The system of claim 11, wherein the post-processor is further configured to:
identify, using the QGNN, which key points are on a target object; and
perform a bounding box prediction using a bounding box prediction pipeline.
